(19) United States
(12) Patent Application Publication
(10) Pub. No.: US 2014/0043836 A1
(43) Pub. Date: Feb. 13, 2014

(54) YIELDABLE LIGHTING COLUMN

(71) Applicant: Anders Welandson, Smalandsstenar (SE)

(72) Inventor: Anders Welandson, Smalandsstenar (SE)

(73) Assignee: AB VARMFORZINKNING, Smalandsstenar (SE)

(21) Appl. No.: 13/805,497

(22) PCT Filed: Jun. 30, 2011
(86) PCT No.: PCT/EP11/60989

§ 371 Date: Oct. 31, 2013

(30) Foreign Application Priority Data
Jul. 8, 2010 (SE) 1050753-1

(51) Int. Cl. E01F 9/018; F21S 8/08

(52) U.S. Cl. CPC E01F 9/018; F21S 8/08
USPC 362/431

(57) ABSTRACT

A yieldable lighting column (1) comprises an elongated, continuous sheet metal shell (3) with a polygonal, preferably octagonal cross-section with internal, stabilizing irons (5) internally attached to the shell (3). The irons are flat irons (5), which are internally attached to each second of the sides of the shell (3) and extend at least in the longitudinal area of the column, where a vehicle may hit the column (1) at collision

### TECHNICAL FIELD

The present invention relates to a yieldable lighting column, comprising an elongated, continuous sheet metal shell with a polygonal, preferably octagonal, cross-section with internal, stabilizing irons internally attached to the shell. It also relates to a method of providing such a lighting column with the ability to yield to a colliding vehicle with minimum damages to the vehicle and its passengers.

### BACKGROUND OF THE INVENTION

Lighting columns placed at the roadside, where there is a risk for a vehicle leaving the road for some reason to collide with them, are customary of a yieldable construction. The hit column will bend over the colliding vehicle and absorb the collision energy in such a way that the damages to the vehicle and its passengers will be kept at a minimum.

It is normal to construct the column from relatively thin sheet metal with a thickness of say 1.5 mm. In order to withstand the wind forces and other forces normally acting on the column, it needs to be stabilized. Conventionally, the stabilizing function can be performed by rod irons internally attached to the shell.

The stiffness of these rod irons will be maintained also at the flattening of the column shell as a result of the collision of a vehicle, and the deformation of the column is not ideal with regard to the damages to the colliding vehicle and injuries to its passengers, as the bending force of the rod irons is the same as before the collision.

A fundamentally different column is shown in WO 99/02779. The shell is made of “a thin gauge metal sheet”, in practice with a thickness of well under 1 mm. This shell does not have enough stability in any part, and therefore all sides of the shell have to be internally stabilized over their entire lengths and practically over their entire widths by strips. The construction is in practice a shell of thick material with weakened corner portions. The deformation properties at a collision are not satisfactory, because “the giving way ability is achieved . . . because of the bent corner portions joining the intermediary flat areas stabilized by the strips” (page 7, lines 2-4). The less satisfactory deformation properties have to do with the lack of free shell areas that should have the possibility to buckle under the forces from a collision.

There is a need to improve the collision properties of a yieldable lighting column of the kind with a shell with normal thickness while maintaining its stability in its normal, upright condition.

### THE INVENTION

This is according to the invention attained in that the irons are flat irons, which are internally attached to each second of the sides of the shell and extend at least in the longitudinal area of the column, where a vehicle may hit the column at a collision.

### BRIEF DESCRIPTION OF THE DRAWINGS

The invention will be described in further detail below under reference to the accompanying drawings, in which

FIG. 1 illustrates a collision between a car and a yieldable lighting column,

FIGS. 2 and 3 are sections through a conventional yieldable lighting column before and after a collision, respectively,

FIGS. 4 and 5 are sections through a yieldable lighting column according to the invention before and after a collision, respectively, and

FIGS. 6 and 7 correspond to FIGS. 4 and 5, respectively, but depict the collision occurring from a slightly different angle.

### DETAILED DESCRIPTION OF EMBODIMENTS

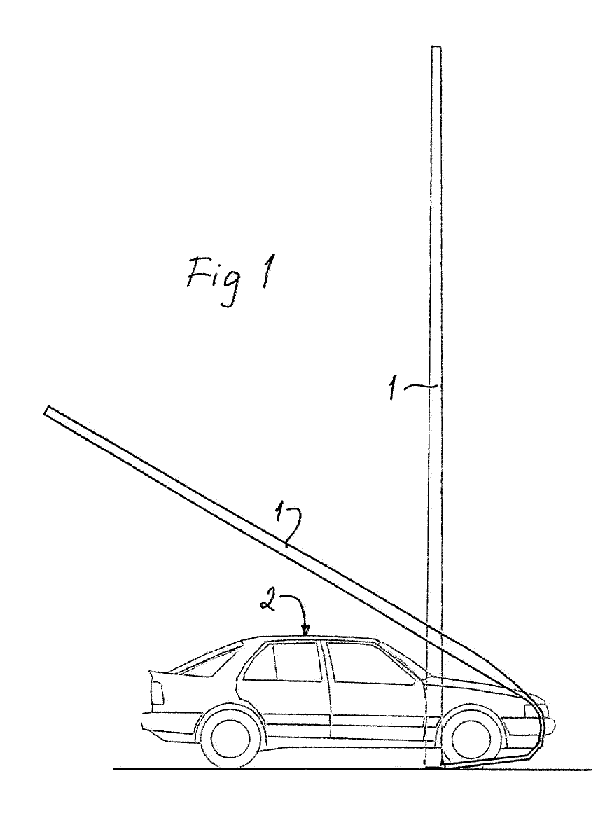

A collision between a yieldable lighting column 1 and a car 2 is illustrated in FIG. 1. In a normal condition the column 1 (provided with a non-shown lighting arrangement, normally at or towards its top) is standing upright, as shown in greyish lines. In a way not shown or described, it is connected (for anchoring to the ground) to a ground attachment of a suitable kind.

If a car 2 hits a lighting column 1, it is of advantage for the driver and passengers of the car, if the column is yieldable, so that it can absorb the kinetic energy of the colliding car over a longer distance, than with a stiff column. As shown in FIG. 1, the colliding car 2 will thus bend down the first portion of the column 1 to the ground, whereas a further portion of the column will be flattened and bent over the car by its front.

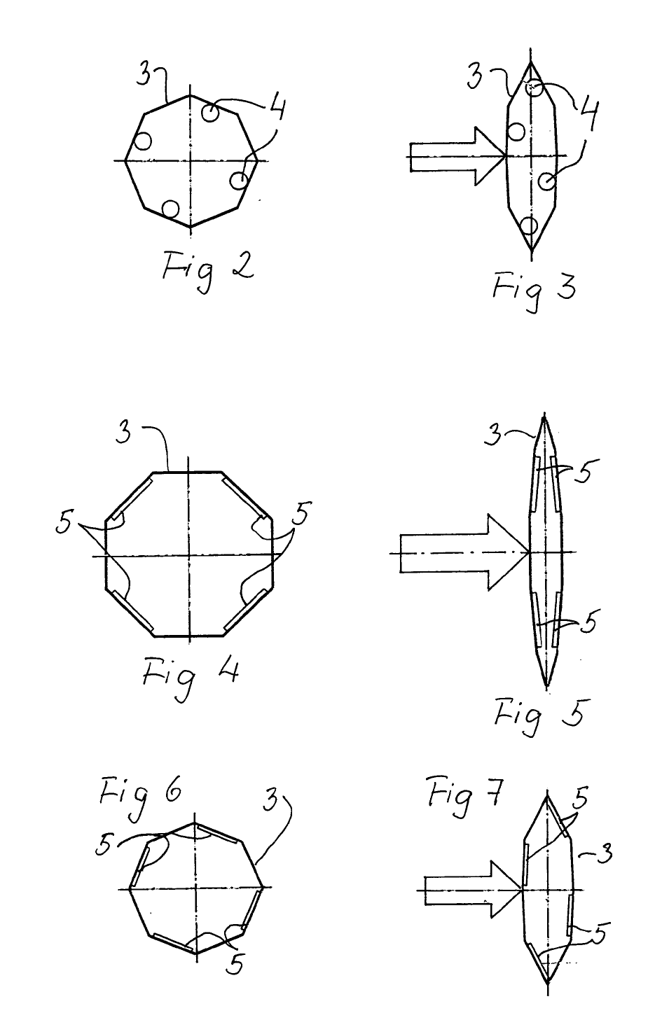

A section through a presently used, yieldable lighting column is shown in FIG. 2. The column is built-up of an octagonal sheet metal shell 3, which preferably tapers slowly upwards. The shell can be built up of several wall units, preferably welded together. The shell structure is reinforced by internal round irons 4, which are attached to the shell, preferably by spot welding or continuous welding. In the shown case, four round irons 4 are attached to the middle of each second of the eight side walls. The number of round irons 4 and their positions within the shell can vary. Also the column shell can have more or less sides than the shown octagonal column, and it can have a rounded cross-sectional shape.

In FIG. 3 the section of the column shown in FIG. 2 has been flattened by a collision. Even if the column is yieldable to a certain extent, the stiffness provided by the four round irons 4 is maintained after the collision and also the bending force during deformation.

In FIG. 4 a section through a column according to the invention is shown. Also in this case the column 1 has an octagonal section and has a sheet metal shell 3, which tapers slowly upwards continuously or stepwise. The sheet metal material (normally galvanized iron) may typically have a thickness of some 1.5 mm, but other thicknesses are possible.

The sheet metal shell 3 is internally provided with plate irons 5 (instead of the conventional round irons 4, shown in FIGS. 2 and 3). These plate irons 5 may preferably be fastened to the sheet metal shell 3 by continuous welding or spot welding. The plate irons 5 may typically have a thickness of some 4 mm, but other thicknesses may be chosen. The width of the plate irons 5 are chosen to be well under the width of each side of the octagonal shell 3.

For the intended function of the yieldable column, the plate irons 5 do not need to extend along the entire height of the column 1; their presence is most important in the area in which a collision with intended bending can occur.

In the shown preferred case, four plate irons 5 are provided, namely at each second of the internal sides of the octagonal column. The intended function may, however, in principle be accomplished with fewer or more plate irons.

When the column 1 is standing upright (FIGS. 2 and 4), the irons 4 or 5 will provide it with the necessary stability and strength, irrespective if they are round irons 4 or flat irons 5. The function at collision and bending is, however, different.

FIG. 5 illustrates a collision at a column side without flat iron. At the collision the column will be flattened, as illustrated, and the column sides perpendicular to the collided side will be bent together. More importantly, however, is that the flat irons 5 follow in the flattening and will attain positions substantially parallel to each other, so that their stiffening function is greatly diminished. Differently speaking, each flat iron 5 will strive to attain a position with the least resistance against bending, or will in other words turn its flat side to the direction of the external force at the collision.

FIG. 7 illustrates a collision against a corner of the column. It appears that also here the flat irons 5 will attain positions with their Oat sides directed towards the force of the collision, so that the stiffness of the column is greatly decreased.

The effect of the provision of the flat irons 5 is mainly that the deformation or bending of the lighting column occurs under decreased deformation force, whereas the intended stability in the normal case with art upright column is maintained. The damages to the colliding vehicle and its passengers will be decreased, while the intended bending of the column is maintained.

Modifications are possible within the scope f the appended claims.

1. A yieldable lighting column, comprising an elongated, continuous sheet metal shell with a polygonal, preferably octagonal, cross-section with internal, stabilizing irons internally attached to the shell, wherein, the irons are flat irons, which are internally attached to each second of the sides of the shell and extend at least in the longitudinal area of the column, where a vehicle may hit the column at a collision.

2. A column according to claim 1, wherein flat irons are attached to the shell by spot welding or continuous welding.

3. A column according to claim 1, wherein the thickness of the flat irons is some 4 mm and of the shell some 1.5 mm.

4. A method of providing a lighting column, comprising an elongated, continuous sheet metal shell with a polygonal, preferably octagonal, cross-section with internal, stabilizing irons internally attached to the shell, with the ability to yield to a colliding vehicle with minimum damages to the vehicle and its passengers, wherein the flat irons are internally attached to each second of the sides of the shell.
